(19) United States
(12) Patent Application Publication
(10) Pub. No.: US 2024/0402550 A1
(43) Pub. Date: Dec. 5, 2024

(54) DISPLAY PANEL AND DISPLAY DEVICE

(71) Applicants: Beijing BOE Optoelectronics Technology Co., Ltd., Beijing (CN); BOE Technology Group Co., Ltd., Beijing (CN)

(72) Inventors: Ce WANG, Beijing (CN); Hongsheng BI, Beijing (CN); Ning LI, Beijing (CN); Bangjun SONG, Beijing (CN); Xuan ZHONG, Beijing (CN)

(21) Appl. No.: 18/701,301

(22) PCT Filed: Jun. 21, 2023
(86) PCT No.: PCT/CN2023/101781

§ 371 Date: Apr. 15, 2024

(30) Foreign Application Priority Data
Jun. 22, 2022 (CN) 202210709735.6

(51) Int. Cl. G02F 1/1362; G02F 1/1368

(52) U.S. Cl. CPC G02F 1/136209; G02F 1/1368

(57) ABSTRACT

A display panel and a display device are disclosed. The display panel includes: an array substrate and an opposite substrate; the display panel includes a display region and a non-display region, the display region includes a main display region and a transition display region, the transition display region has a plurality of transition pixel units, and each of the transition pixel units includes a plurality of transition sub-pixels; and a black matrix defines a plurality of transition sub-pixel opening regions in the transition display region, an orthographic projection of an edge of each transition sub-pixel opening region close to the gate line on the array substrate falls within an orthographic projection of the corresponding transition sub-pixel on the array substrate, and the edge is in a shape of a straight line.

The present disclosure is a National Stage of International Application No. PCT/CN2023/101781 filed on Jun. 21, 2023, which claims priority to Chinese Patent Application No. 202210709735.6, filed on Jun. 22, 2022 and entitled “DISPLAY PANEL AND DISPLAY DEVICE”, the disclosure of both of which are herein incorporated by reference in their entirety.

### TECHNICAL FIELD

The present disclosure relates to the field of display technologies, and in particular to a display panel and a display device.

### BACKGROUND

Currently, liquid crystal display panels (LCD panels) have become popular products. The LCD panel includes a thin film transistor (TFT) array substrate and a color film substrate facing each other. A post space (PS) is arranged between the color film substrate and the TFT array substrate. The color film substrate usually includes a black matrix (BM) to avoid light leakage and color mixing.

### SUMMARY

The present disclosure provides a display panel and a display device.

In a first aspect, embodiments of the present disclosure provide a display panel. The display panel includes: an array substrate and an opposite substrate facing each other, wherein a black matrix is provided on a side of the opposite substrate facing the array substrate, and the array substrate includes a plurality of rows of gate lines;

the display panel includes a display region and a non-display region, the display region includes a main display region and a transition display region which is between the main display region and the non-display region, the transition display region has a plurality of transition pixel units, and each of the transition pixel units includes a plurality of transition sub-pixels; and the black matrix defines a plurality of transition sub-pixel opening regions in the transition display region, the plurality of transition sub-pixel opening regions correspond to the transition sub-pixels in the transition display region, an orthographic projection of an edge of each transition sub-pixel opening region close to the gate line on the array substrate falls within an orthographic projection of the corresponding transition sub-pixel on the array substrate, and the edge of each transition sub-pixel opening region close to the gate line is in the shape of a straight line.

In some embodiments, the main display region has a plurality of main pixel units therein, and each of the main pixel units includes a plurality of main sub-pixels; and
the area of the transition sub-pixel opening regions is smaller than that of the main sub-pixel opening regions.

In some embodiments, the areas of the transition sub-pixel opening regions gradually increase along the row direction from the non-display region to the main display region, and the area of each of the transition sub-pixel opening regions in one of the transition pixel units has the same value.

In some embodiments, the areas of the transition sub-pixel opening regions gradually increase along a column direction from the non-display region to the main display region, and the area of each of the transition sub-pixel opening regions in one of the transition pixel units has the same value.

In some embodiments, each of the transition sub-pixel opening regions has a first edge and a second edge opposite each other, both the first edge and the second edge are in a shape of a straight line and extend in the row direction, and orthographic projections of the first edge and the second edge on the array substrate are both within the orthographic projection of the corresponding transition sub-pixel on the array substrate.

In some embodiments, first edges corresponding to the transition sub-pixels in one of the transition pixel units are on a first straight line, and the first straight line is parallel to the row direction.

In some embodiments, second edges corresponding to the transition sub-pixels in one of the transition pixel units are on a second straight line, and the second straight line is parallel to the row direction.

In some embodiments, each of the transition sub-pixels has a first side edge and a second side edge opposite each other, a direction from the first side edge to the second side edge is parallel to the column direction, and the first side edge is closer to the main display region than the second side edge; and
a first distance is present between the first side edge of each of the transition sub-pixels and the first edge of the corresponding transition sub-pixel opening region, a second distance is present between the second side edge of each of the transition sub-pixels and the second edge of the corresponding transition sub-pixel opening region, the first edge is closer to the main display region than the second edge, and the second distance is larger than the first distance.

In some embodiments, the first distance of each of the transition sub-pixels in the transition display region is the same.

In some embodiments, the second distance of each of the transition sub-pixels in the transition display region is positively correlated to a distance from the transition sub-pixel to the display region.

In some embodiments, each of the transition sub-pixel opening regions has a third edge and a fourth edge opposite each other, and the third edge is in the shape of a straight line extending in the column direction.

In some embodiments, the fourth edge is in the shape of a straight line extending in the column direction.

In some embodiments, each of the transition sub-pixels has a third side edge and a fourth side edge opposite each other, a direction from the third side edge to the fourth side edge is parallel to the row direction, and the third side edge is closer to the non-display region than the fourth side edge; and
a third distance is present between the third side edge of each of the transition sub-pixels and the third edge of the corresponding transition sub-pixel opening region, a fifth distance is present between each of the main sub-pixels in the main display region and the corresponding opening region, the third distance is larger than the fifth distance, and the third edge is closer to the non-display region than the fourth edge.

In some embodiments, a difference value between the third distance and the fifth distance is positively correlated to a distance between a transition sub-pixel to which the third distance belongs and the display region.

In some embodiments, a fourth distance is present between the fourth side edge of each of the transition sub-pixels and the fourth edge of the corresponding transition sub-pixel opening region, a sixth distance is present between each of the main sub-pixels in the main display region and the corresponding opening region, and the fourth distance is larger than the sixth distance.

In some embodiments, a difference value between the fourth distance and the sixth distance is positively correlated to a distance between a transition sub-pixel to which the fourth distance belongs and the display region.

In some embodiments, each of the transition sub-pixels has a first side edge and a second side edge opposite each other, a direction from the first side edge to the second side edge is parallel to the column direction, and the first side edge is closer to the main display region than the second side edge; and
a first distance is present between the first side edge of each of the transition sub-pixels and the first edge of the corresponding transition sub-pixel opening region, a second distance is present between the second side edge of each of the transition sub-pixels and the second edge of the corresponding transition sub-pixel opening region, the first edge is closer to the main display region than the second edge, and the second distance and the first distance are the same.

In some embodiments, a plurality of spacers are provided between the array substrate and the opposite substrate, and an orthographic projection of the spacers on the array substrate falls within an orthographic projection of the black matrix on the array substrate.

In some embodiments, the orthographic projection of the spacers on the array substrate at least partially overlaps with thin-film transistors on the array substrate.

In a second aspect, the embodiments of the present disclosure provide a display device. The display device includes a display panel. The display panel includes: an array substrate and an opposite substrate facing each other, wherein a black matrix is provided on a side of the opposite substrate facing the array substrate, and the array substrate includes a plurality of rows of gate lines;
the display panel includes a display region and a non-display region, the display region includes a main display region and a transition display region which is between the main display region and the non-display region, the transition display region has a plurality of transition pixel units, and each of the transition pixel units includes a plurality of transition sub-pixels; and
the black matrix defines a plurality of transition sub-pixel opening regions in the transition display region, the plurality of transition sub-pixel opening regions correspond to the transition sub-pixels in the transition display region, an orthographic projection of an edge of each transition sub-pixel opening region close to the gate line on the array substrate falls within an orthographic projection of the corresponding transition sub-pixel on the array substrate, and the edge of each transition sub-pixel opening region close to the gate line is in the shape of a straight line.

### BRIEF DESCRIPTION OF THE DRAWINGS

Other features, objects and advantages of the present disclosure will become more apparent upon reading of the description of non-limiting embodiments thereof with reference to the following accompanying drawings:

FIG. 1 is a schematic structural diagram of gray scale transition design of a display panel (in which an array substrate is a single gate line type) according to the related art;

FIG. 2 is a schematic structural diagram of a conventional transition sub-pixel of a display panel (in which an array substrate is a double gate line type) according to the related art;

FIG. 3 is a schematic structural diagram of gray scale transition design of a display panel (in which an array substrate is a dual gate line type) according to the related art;

FIG. 4 is a schematic diagram of smooth transition from a display region to a non-display region according to some embodiments of the present disclosure;

FIG. 5 is a schematic structural diagram of a transition pixel unit in a transition display region of a display panel according to some embodiments of the present disclosure;

FIG. 6 is a schematic structural diagram of another transition pixel unit in a transition display region of a display panel according to some embodiments of the present disclosure; and

FIG. 7 is a schematic structural diagram of still another transition pixel unit in a transition display region of a display panel according to some embodiments of the present disclosure.

### DETAILED DESCRIPTION

The present disclosure will be further described in detail below with reference to the accompanying drawings and the embodiments. It should be understood that the specific embodiments described herein are merely illustrative of the present disclosure and are not to be construed as limiting the present disclosure. In addition, it should be noted that, for convenience of description, only the portions related to the present disclosure are shown in the accompanying drawings.

It should be noted that the embodiments and features of the embodiments in the present disclosure may be combined with each other without conflict. The present disclosure will be described in detail below with reference to the accompanying drawings in conjunction with embodiments.

Aiming at a special-shaped screen, a liquid crystal display panel includes a display region and a non-display region, the display region includes a main display region and a transition display region, and the transition display region is disposed between the main display region and the non-display region. In the longitudinal direction of the display panel, a data pad (DP) side is usually disposed at the lower side of the display panel, and correspondingly, the upper side of the display panel is a data pad opposite (DPO) side. In the liquid crystal display panel, a black matrix (BM) is adopted on the side of an opposite substrate to form a light-opaque region. For the transition display region, a portion of light-emitting regions of transition sub-pixels in the transition display region is shielded by the black matrix to form transition sub-pixel opening regions. For example, in the case that a liquid crystal display panel (LCD panel) is applied to a series of special-shaped screen designs with water drop, notch, punch hole and the like, the screen edge or the arc edges of the surrounding fillets of the special-shaped screen is prone to have a visual burr. At present, a black matrix is configured to shield a portion of the pixel opening regions of the pixels to achieve smooth gray scale transition, such that the burr feeling is reduced.

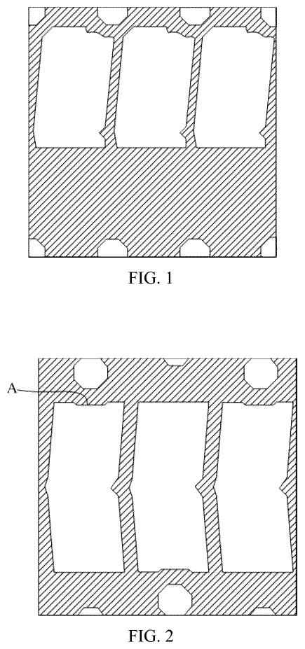

In the pixel gray scale transition design of the display panel, referring to FIG. 1, the array substrate of the display panel is a single gate line type array substrate, the oblique line filling region indicates a black matrix (BM), and a black matrix material is provided on the DP side from bottom to top to shield a portion of the light-emitting regions of the transition sub-pixels, such that the transition sub-pixel opening regions are formed. Correspondingly, a black matrix material is provided on the DPO side from top to bottom to shield a portion of the light-emitting regions of the transition sub-pixels, such that the transition sub-pixel opening regions are formed. The black matrix material is provided from bottom to top to shield a portion of the light-emitting regions of the transition sub-pixels, which means that the black matrix material is preferentially configured to shield the lower portion of the light-emitting regions of the transition sub-pixels. The black matrix material is provided from top to bottom to shield a portion of the light-emitting regions of the transition sub-pixels, which means that the black matrix material is preferentially configured to shield the upper portion of the light-emitting regions of the transition sub-pixels.

Each transition pixel unit includes three transition sub-pixels, i.e., a red R transition sub-pixel, a green G transition sub-pixel and a blue B transition sub-pixel, the opening region of each transition sub-pixel in the transition pixel unit in the transition display region can be consistent by coating with the black matrix material in a single direction, and the smooth gray scale transition from the main display region to the non-display region can be achieved by adjusting the opening sizes of different transition sub-pixels.

In recent years, small-sized LCD panels are mostly driven by dual gate line technology due to the restriction of chip type selection, and a corresponding thin-film transistor (TFT) array substrate is a dual gate line type TFT array substrate. Referring to FIG. 2, a gap between an array substrate and an opposite substrate is reduced by pressure, spacers disposed therebetween are pressed into transition sub-pixel opening regions to affect the deflection of the liquid crystal, and protrusion portions A are provided at portions of the black matrix corresponding to the spacers during design, and the protrusion portions A intrude into the transition sub-pixel opening regions.

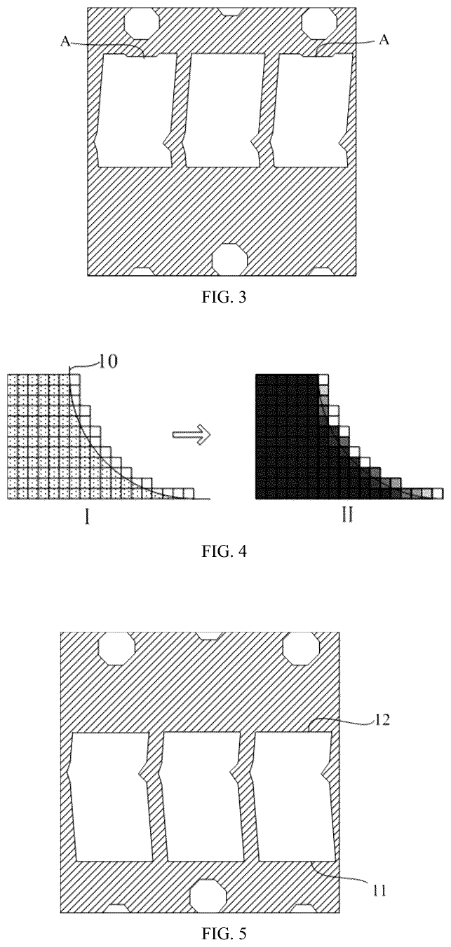

As the portions of the black matrix corresponding to the spacers are provided with the protrusion portions A which intrude into the transition sub-pixel opening regions, referring to a transition pixel unit disposed on the DP side shown in FIG. 3, corresponding to two adjacent sub-pixels in a row of pixels, the black matrix will intrude into the opening regions of the two sub-pixels from the upper and lower directions respectively in the form of protrusion portions (i.e. one sub-pixel opening region is intruded from the upper side by the black matrix, and the other sub-pixel opening region is intruded from the lower side by the black matrix). Two adjacent TFT units in a row of TFT units are mostly in central symmetry and appear in pairs. In the case that the black matrix is configured to directly shield from one side, the opening regions of the pixels are not consistent in size, such that the gray scale transition is not smooth, and the problem of poor display is caused. Therefore, in the case that the black matrix material is provided in the manner shown in FIG. 1, the sizes of all the transition sub-pixel opening regions in the transition pixel unit cannot be guaranteed to be consistent, which may cause the problems of unsmooth gray scale transition and the like.

FIG. 4 illustrates smooth transition from a display region to a non-display region. FIG. 41 illustrates the display region and the non-display region separated by a boundary 10, where the left side of the boundary 10 is the non-display region, the right side of the boundary 10 is a main display region, a pixel unit where the boundary 10 is located is a transition pixel unit, and the transition pixel unit constitutes a transition display region. FIG. 4II is a schematic diagram illustrating the gray scale transition from the non-display region to the main display region through the transition display region.

The embodiments of the present disclosure provide a display panel.

The display panel includes an array substrate and an opposite substrate facing each other, wherein a black matrix is provided on a side of the opposite substrate facing the array substrate, and the array substrate includes a plurality of rows of gate lines.

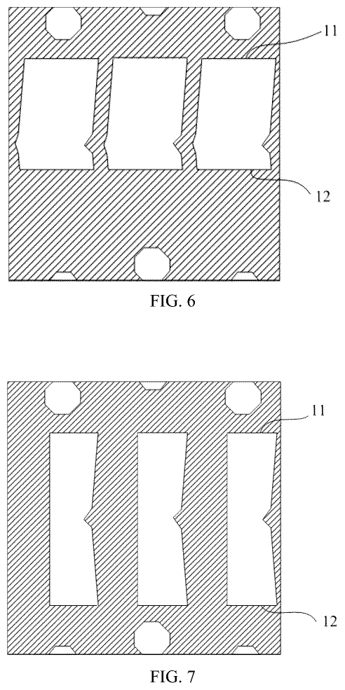

The display panel includes a display region and a non-display region. The display region includes a main display region and a transition display region which is between the main display region and the non-display region. The transition display region has a plurality of transition pixel units. Referring to FIG. 5, the transition pixel unit includes a plurality of transition sub-pixels; and
the black matrix defines a plurality of transition sub-pixel opening regions in the transition display region. The plurality of transition sub-pixel opening regions correspond to the transition sub-pixels in the transition display region. An orthographic projection of an edge of each transition sub-pixel opening region close to the gate line on the array substrate falls within an orthographic projection of the corresponding transition sub-pixel on the array substrate, and the edge of each transition sub-pixel opening region close to the gate line is in the shape of a straight line.

In the embodiments of the present disclosure, the orthographic projection of the edge of each transition sub-pixel opening region close to the gate line on the array substrate falls within the orthographic projection of the corresponding transition sub-pixel on the array substrate, such that a portion of light-emitting regions of the transition sub-pixels can be shielded by the black matrix, and the opening regions of the transition sub-pixels are smaller than the light-emitting regions of the transition sub-pixels, which is beneficial to achieving the gray scale transition from the main display region to the non-display region. Meanwhile, the edge of each transition sub-pixel opening region close to the gate line is the straight edge, such that the black matrix shields the transition sub-pixels at the edge close to the gate line by the straight edge instead of intruding into the transition sub-pixels in the form of protrusion portions, the area inconsistency of the opening regions of the plurality of transition sub-pixels in one transition pixel unit in the transition display region can be avoided, and the area inconsistency of the opening regions of the transition sub-pixels with the same gray scale can further be avoided.

In the display panel provided by the embodiments, the array substrate is a dual gate line type array substrate, that is, two gate lines are provided between adjacent rows of sub-pixels. The array substrate has a plurality of thin-film transistors. A plurality of spacers are provided between the array substrate and the opposite substrate, and an orthographic projection of the spacers on the array substrate falls within an orthographic projection of the black matrix on the array substrate. In this way, the spacers will not enter the transition sub-pixel opening regions even if being squeezed, and the normal deflection of the liquid crystal can be ensured.

In some embodiments, the spacers at least partially overlap the thin-film transistors on the array substrate. For example, the spacers and the thin-film transistors on the array substrate may be arranged in a one-to-one correspondence. In the case that the two adjacent transition sub-pixels in the same row are in a central symmetry structure, the spacers corresponding to the two adjacent transition sub-pixels in the same row are further in a central symmetry structure.

The main display region of the display panel is further provided with a plurality of main pixel units, and each of the main pixel units includes a plurality of main sub-pixels. The black matrix defines a plurality of main sub-pixel opening regions in the main display region. The plurality of main sub-pixel opening regions correspond to the plurality of main sub-pixels. In some embodiments, an orthographic projection of an edge of each main sub-pixel opening region close to the gate line on the array substrate falls within an orthographic projection of the corresponding main sub-pixel on the array substrate, and the edge of each main sub-pixel opening region close to the gate line is in the shape of a straight line. In the case that the orthographic projection of the edge of each main sub-pixel opening region close to the gate line on the array substrate falls within an orthographic projection of the corresponding main sub-pixel on the array substrate, the normal light emission of the main sub-pixels can be ensured, and metal wires and the like of the main sub-pixels are shielded, such that the normal display of the main display region is prevented from being influenced. In addition, the edge of each main sub-pixel opening region close to the gate line is the straight edge, such that the black matrix shields the main sub-pixels at the edge close to the gate line by the straight edge instead of intruding into the main sub-pixels in the form of protrusion portions, the area inconsistency of the opening regions of the plurality of main sub-pixels in one main pixel unit in the main display region can be avoided, and the area inconsistency of the opening regions of the main sub-pixels with the same gray scale can further be avoided.

Further, the area of each opening region of the main pixel units is the same, and the area of each main sub-pixel opening region in the main pixel units is the same. Through the design, the displaying brightness of each main pixel unit in the main display region has the same value, and it is ensured that the display panel has a higher display effect.

Meanwhile, the area of the transition sub-pixel opening regions is smaller than that of the main sub-pixel opening regions. Therefore, the brightness of the transition pixel units in the transition display region is smaller than that of the main pixel units in the main display region, and smooth gray scale transition from the main display region to the non-display region can be ensured.

Further, the areas of the opening regions of the transition pixel units gradually increase along a row direction from the non-display region to the main display region. On the basis, the areas of the transition sub-pixel opening regions gradually increase, and the area of each of the transition sub-pixel opening regions in one transition pixel unit has the same value.

Similarly, the areas of the opening regions of the transition pixel units gradually increase along a column direction from the non-display region to the main display region. On this basis, the areas of the transition sub-pixel opening regions gradually increase, and the area of each of the transition sub-pixel opening regions in one transition pixel unit has the same value.

Through the design, the brightness gradually increases from the non-display region to the main display region, which is beneficial to achieving smooth gray scale transition from the display region to the non-display region.

In some embodiments, each of the transition sub-pixel opening regions has a first edge and a second edge opposite each other in the foregoing column direction, both the first edge and the second edge are in a shape of a straight line and extend in the row direction, and orthographic projections of the first edge and the second edge on the array substrate are both within the orthographic projection of the corresponding transition sub-pixel on the array substrate. In this way, the black matrix shields the transition sub-pixels at the first edge and the second edge by the straight edges instead of intruding into the transition sub-pixels in the form of protrusion portions, the area inconsistency of the opening regions of the plurality of transition sub-pixels in one transition pixel unit in the transition display region can be avoided, and the area inconsistency of the opening regions of the transition sub-pixels with the same gray scale can further be avoided.

In some embodiments, the first edges corresponding to the plurality of transition sub-pixels in one transition pixel unit are on a first straight line, and the first straight line is parallel to the row direction. Similarly, the second edges corresponding to the plurality of transition sub-pixels in one transition pixel unit are on a second straight line, and the second straight line is parallel to the row direction.

The design can ensure that the area of each transition sub-pixel opening region in one transition pixel unit is kept consistent, such that the opening regions of the transition sub-pixels with the same gray scale are consistent, and accordingly the smooth gray scale transition from the main display region to the non-display region is ensured.

Further, each of the transition sub-pixels has a first side edge and a second side edge opposite each other, a direction from the first side edge to the second side edge is parallel to the column direction, and the first side edge is closer to the main display region than the second side edge.

In the case that the first edge is closer to the main display region than the second edge, a first distance is present between the first side edge of each of the transition sub-pixels and the first edge of the corresponding transition sub-pixel opening region, a second distance is present between the second side edge of each of the transition sub-pixels and the second edge of the corresponding transition sub-pixel opening region, and the second distance is larger than the first distance.

The first edge is close to the display region, the second edge is close to the non-display region, and the second distance is designed to be larger than the first distance, such that each transition sub-pixel opening region in the transition display region is close to the main display region as much as possible, such that the smooth gray scale transition from the main display region to the non-display region is facilitated.

Further, the first distance of each of the transition sub-pixel in the transition display region is the same. In this way, by adjusting the second distance (corresponding to the portion between the second edge of the transition sub-pixel opening region covered with the black matrix and the second side edge of the transition sub-pixel), the size of the transition sub-pixel opening regions with different gray scales can be adjusted, such that the smooth gray scale transition from the display region to the non-display region can be simply and rapidly achieved.

In some embodiments, the second distance of each of the transition sub-pixels in the transition display region can vary with a distance from the transition sub-pixel to the display region. For example, the second distance of each of the transition sub-pixels in the transition display region is positively correlated to the distance from the transition sub-pixel to the display region. In this way, smooth gray scale transition from the main display region to the non-display region can be achieved.

FIG. 5 is a schematic diagram of a transition pixel unit applicable to a DPO side according to some embodiments of the present disclosure. As shown in FIG. 5, in the transition pixel unit, a black matrix is provided from bottom to top according to a first distance. A first edge 11 corresponding to each transition sub-pixel in one transition pixel unit is disposed on a first straight line parallel to the row direction. A black matrix is provided from top to bottom according to a second distance. A second edge 12 corresponding to each transition sub-pixel in one transition pixel unit is disposed on a second straight line parallel to the row direction. The first distance of the transition pixel units with different gray scales is the same, and the second distance of the transition pixel units with different gray scales is different, such that the black matrixes define the transition sub-pixel opening regions in the transition display region.

FIG. 6 is a schematic diagram of a transition pixel unit applicable to a DP side according to some embodiments of the present disclosure. As shown in FIG. 6, in the transition pixel unit, a black matrix is provided from top to bottom according to a first distance. A first edge 11 corresponding to each transition sub-pixel in one transition pixel unit is disposed on a first straight line parallel to the row direction. A black matrix is provided from bottom to top according to a second distance. A second edge 12 corresponding to each transition sub-pixel in one transition pixel unit is disposed on a second straight line parallel to the row direction. The first distance of the transition pixel units with different gray scales is the same, and the second distance of the transition pixel units with different gray scales is different, such that the black matrixes define the transition sub-pixel opening regions in the transition display region.

In some embodiments, each of the transition sub-pixel opening regions has a third edge and a fourth edge opposite each other, and the third edge and/or the fourth edge are/is in the shape of a straight line extending in the column direction. In this way, the black matrix shields the transition sub-pixels at the third edge and/or the fourth edge by the straight edges instead of intruding into the transition sub-pixels in the form of protrusion portions, the area inconsistency of the opening regions of the plurality of transition sub-pixels in one transition pixel unit in the transition display region can be avoided, and the area inconsistency of the opening regions of the transition sub-pixels with the same gray scale can further be avoided.

In addition, each of the transition sub-pixels has a third side edge and a fourth side edge opposite each other, a direction from the third side edge to the fourth side edge is parallel to the row direction, and the third side edge is closer to the non-display region than the fourth side edge.

In the case that the third edge is in the shape of a straight line extending in the column direction, a third distance is present between the third edge and the third side edge. In the case that the fourth edge is in the shape of a straight line extending in the column direction, a fourth distance is present between the fourth edge and the fourth side edge.

At least one of the left and right edges of each transition sub-pixel opening region is shifted toward the middle of the opening region in the row direction relative to the positions of the left and right edges of a main sub-pixel opening region. That is, a black matrix is provided on one side of the third edge at least at the third distance, or a black matrix is provided on one side of the fourth edge at least at the fourth distance, such that a portion of light-emitting regions of the transition sub-pixels is shielded, and accordingly the transition sub-pixel opening regions in one transition pixel unit are consistent.

In some embodiments, a third distance is present between the third side edge of each of the transition sub-pixels and the third edge of the corresponding transition sub-pixel opening region, a fifth distance is present between each of the main sub-pixels in the main display region and the corresponding opening region, and the third distance is larger than the fifth distance. Meanwhile, a difference value between the third distance and the fifth distance is positively correlated to a distance between a transition sub-pixel to which the third distance belongs and the display region. Similarly, a fourth distance is present between the fourth side edge of each of the transition sub-pixels and the fourth edge of the corresponding transition sub-pixel opening region, a sixth distance is present between each of the main sub-pixels in the main display region and the corresponding opening region, and the fourth distance is larger than the sixth distance. Meanwhile, a difference value between the fourth distance and the sixth distance is positively correlated to a distance between a transition sub-pixel to which the fourth distance belongs and the display region. In this way, smooth gray scale transition from the main display region to the non-display region can be achieved.

Further, each of the transition sub-pixels has a first side edge and a second side edge opposite each other, a direction from the first side edge to the second side edge is parallel to the column direction, and the first side edge is closer to the main display region than the second side edge. In the case that the first edge is closer to the main display region than the second edge, a first distance is present between the first side edge of each of the transition sub-pixels and the first edge of the corresponding transition sub-pixel opening region, a second distance is present between the second side edge of each of the transition sub-pixels and the second edge of the corresponding transition sub-pixel opening region, and the second distance and the first distance are the same.

The design can prevent the black matrix from intruding into the opening regions in the form of protrusion portions, and ensure the consistency of the transition sub-pixel opening regions in one transition pixel unit.

Referring to FIG. 7, the left side of a transition pixel unit is a non-display region, and the right side is a display region. An edge on the left side of a transition sub-pixel opening region is a third edge of the transition sub-pixel opening region, and an edge on the right side of the transition sub-pixel opening region is a fourth edge of the transition sub-pixel opening region. A black matrix is provided on the left side of the third edge at a third distance, and the third edge is in the shape of a straight line extending in the column direction. Meanwhile, a black matrix is provided at a first distance (or a second distance) in the upward and downward directions in the column direction. The black matrixes shield a portion of light-emitting regions of transition sub-pixels, such that the transition sub-pixel opening regions in one transition pixel unit are consistent.

Based on the same inventive concept, the embodiments of the present disclosure provide a display device. The display device includes the above-mentioned display panel.

The display device according to the embodiments of the present disclosure may be liquid crystal products, such as a mobile phone, a computer display, a tablet computer, a vehicle-mounted screen, and a camera.

In the description of the present disclosure, it should be understood that directions or positional relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, “circumferential”, and the like are those shown based on the accompanying drawings, are merely intended to facilitate and simplify description rather than to indicate or imply that the indicated apparatus or element must have a specific direction and be structured and operated according to the specific direction, and should not be construed as limiting the present disclosure.

The present disclosure employs “first”, “second”, etc. to describe various information, but the information should not be limited to these terms. These terms are only used to distinguish one type of information from another. For example, first information may also be referred to as second information, and similarly, second information may also be referred to as first information, without departing from the scope of the present disclosure.

In the description of the present disclosure, it should be noted that unless otherwise explicitly specified or limited, the terms “mount,” “connect,” and “connection” shall be understood in a broad sense and may be, for example, fixed connection, detachable connection, or integrated connection; or mechanical connection or electrical connection; or direct connection, indirect connection via an intermediate medium; or internal communication between two elements, wireless connection, or wired connection. For those of ordinary skill in the art, the specific meaning of the above terms in the present disclosure may be understood according to the specific condition.

The foregoing description is merely preferred embodiments of the present disclosure and is illustrative of the principles of the technology employed. It should be understood by those skilled in the art that the scope of the present disclosure is not limited to technical solutions formed by specific combinations of the above technical features, but should also cover other technical solutions formed by any combination of the above technical features or their equivalent features without departing from the idea of the present disclosure. For example, technical solutions are formed by substituting the above features with technical features having similar functions disclosed (but not limited to) in the present disclosure.

1. A display panel, comprising: an array substrate and an opposite substrate facing each other, wherein a black matrix is provided on a side, facing the array substrate, of the opposite substrate, and the array substrate comprises a plurality of gate lines extending in a row direction of the array substrate;
the display panel comprises a display region and a non-display region, the display region comprises a main display region and a transition display region which is between the main display region and the non-display region, the transition display region has a plurality of transition pixel units, and each of the transition pixel units comprises a plurality of transition sub-pixels; and
the black matrix defines a plurality of transition sub-pixel opening regions in the transition display region, the transition sub-pixel opening regions correspond to the transition sub-pixels in the transition display region, an orthographic projection of an edge, extending in the row direction, of each transition sub-pixel opening region close to the gate line on the array substrate falls within an orthographic projection of a corresponding transition sub-pixel on the array substrate, and the edge, extending in the row direction, of each transition sub-pixel opening region is in a shape of a straight line.

2. The display panel according to claim 1, wherein the main display region has a plurality of main pixel units, and each of the main pixel units comprises a plurality of main sub-pixels; and
the black matrix defines a plurality of main sub-pixel opening regions in the main display region, the main sub-pixel opening regions correspond to the main sub-pixels in the main display region, and an area of the transition sub-pixel opening regions is smaller than an area of the main sub-pixel opening regions.

3. The display panel according to claim 2, wherein area values of the transition sub-pixel opening regions gradually increase along the row direction from the non-display region to the main display region, and an area of each of the transition sub-pixel opening regions in one of the transition pixel units has the same value.

4. The display panel according to claim 2, wherein area of the transition sub-pixel opening regions gradually increase along a column direction of the array substrate from the non-display region to the main display region, and the area of each of the transition sub-pixel opening regions in one of the transition pixel units has the same value.

5. The display panel according to claim 1, wherein each of the transition sub-pixel opening regions has a first edge and a second edge which are respectively on two opposite sides of the transition sub-pixel opening region, both the first edge and the second edge are in a shape of a straight line and extend in the row direction, and orthographic projections of the first edge and the second edge on the array substrate are both within the orthographic projection of the corresponding transition sub-pixel on the array substrate.

6. The display panel according to claim 5, wherein first edges corresponding to the transition sub-pixels in one of the transition pixel units are on a first straight line, and the first straight line is parallel to the row direction.

7. The display panel according to claim 5, wherein second edges corresponding to the transition sub-pixels in one of the transition pixel units are on a second straight line, and the second straight line is parallel to the row direction.

8. The display panel according to claim 5, wherein each of the transition sub-pixels has a first side edge and a second side edge-opposite which are respectively on two opposite sides of the transition sub-pixel, a direction from the first side edge to the second side edge is parallel to a column direction of the array substrate, and the first side edge is closer to the main display region than the second side edge; and
a first distance is present between the first side edge of each of the transition sub-pixels and a first edge of a corresponding transition sub-pixel opening region, a second distance is present between the second side edge of each of the transition sub-pixels and a second edge of a corresponding transition sub-pixel opening region, the first edge is closer to the main display region than the second edge, and the second distance is larger than the first distance.

9. The display panel according to claim 8, wherein the first distance of each of the transition sub-pixels in the transition display region is the same.

10. The display panel according to claim 8-or 9, wherein the second distance of each of the transition sub-pixels in the transition display region is positively correlated to a distance from the transition sub-pixel to the display region.

11. The display panel according to claim 5, wherein each of the transition sub-pixel opening regions has a third edge and a fourth edge which are respectively on two opposite sides of the transition sub-pixel opening region, and the third edge is in a shape of a straight line and extends in a column direction of the array substrate.

12. The display panel according to claim 11, wherein the fourth edge is in a shape of a straight line and extends in the column direction.

13. The display panel according to claim 11, wherein each of the transition sub-pixels has a third side edge and a fourth side edge which are respectively on two opposite sides of the transition sub-pixel, a direction from the third side edge to the fourth side edge is parallel to the row direction, and the third side edge is closer to the non-display region than the fourth side edge; and
a third distance is present between the third side edge of each of the transition sub-pixels and a third edge of a corresponding transition sub-pixel opening region, a fifth distance is present between each of the main sub-pixels in the main display region and a corresponding main sub-pixel opening region, the third distance is larger than the fifth distance, and the third edge is closer to the non-display region than the fourth edge.

14. The display panel according to claim 13, wherein a difference value between the third distance and the fifth distance is positively correlated to a distance between a transition sub-pixel to which the third distance belongs and the display region.

15. The display panel according to claim 13, wherein a fourth distance is present between the fourth side edge of each of the transition sub-pixels and a fourth edge of a corresponding transition sub-pixel opening region, a sixth distance is present between each of the main sub-pixels in the main display region and a corresponding main sub-pixel opening region, and the fourth distance is larger than the sixth distance.

16. The display panel according to claim 15, wherein a difference value between the fourth distance and the sixth distance is positively correlated to a distance between a transition sub-pixel to which the fourth distance belongs and the display region.

17. The display panel according to claim 11, wherein each of the transition sub-pixels has a first side edge and a second side edge which are respectively on two opposite sides of the transition sub-pixel, a direction from the first side edge to the second side edge is parallel to the column direction, and the first side edge is closer to the main display region than the second side edge; and
a first distance is present between the first side edge of each of the transition sub-pixels and a first edge of a corresponding transition sub-pixel opening region, a second distance is present between the second side edge of each of the transition sub-pixels and a second edge of a corresponding transition sub-pixel opening region, the first edge is closer to the main display region than the second edge, and the second distance and the first distance are the same.

18. The display panel according to claim 1, wherein a plurality of spacers are provided between the array substrate and the opposite substrate, and an orthographic projection of the spacers on the array substrate falls within an orthographic projection of the black matrix on the array substrate.

19. The display panel according to claim 18, wherein the orthographic projection of the spacers on the array substrate at least partially overlaps with an orthographic projection of thin-film transistors on the array substrate.

20. A display device, comprising a display panel, wherein the display panel comprises: an array substrate and an opposite substrate facing each other, a black matrix is provided on a side, facing the array substrate, of the opposite substrate, and the array substrate comprises a plurality of gate lines extending in a row direction of the array substrate;
the display panel comprises a display region and a non-display region, the display region comprises a main display region and a transition display region which is between the main display region and the non-display region, the transition display region has a plurality of transition pixel units, and each of the transition pixel units comprises a plurality of transition sub-pixels; and
the black matrix defines a plurality of transition sub-pixel opening regions in the transition display region, the transition sub-pixel opening regions correspond to the transition sub-pixels in the transition display region, an orthographic projection of an edge, extending in the row direction, of each transition sub-pixel opening region on the array substrate falls within an orthographic projection of a corresponding transition sub-pixel on the array substrate, and the edge, extending in the row direction, of each transition sub-pixel opening region is in a shape of a straight line.
